(19) United States
(12) Patent Application Publication
(10) Pub. No.: US 2021/0221242 A1
(43) Pub. Date: Jul. 22, 2021

(54) Development of Resilient In-Wheel-Motor (RIWM) technology

(71) Applicant: Hossam Gaber, North York (CA)

(72) Inventor: Hossam Gaber, North York (CA)

(21) Appl. No.: 16/748,778

(22) Filed: Jan. 21, 2020

(51) Int. Cl. B60L 53/22; B60L 7/18; B60K 7/00; B60L 50/60

(52) U.S. Cl. CPC B60L 53/22; B60L 7/18; B60L 7/12; B60L 50/60; B60K 7/0007

(57) ABSTRACT

The patent presents Resilient In-Wheel-Motor (RIWM) technology with an enhanced scheme to control the regenerative power that can be delivered by hybrid and electric vehicles to be faster and with a lower total cost than other electric drive systems. Hub motors have been included a built-in inverter, control electronics, software and smart battery management that simplify the adoption of hybrid and electrified powertrains across a broad range of vehicles, based on add new performance feature to handle some existing challenges that will be mentioned bellow. The objective of the paper is to propose hub motor that is incorporated with high-speed dynamic energy storage as fast batteries, ultracapacitors and small flywheel units. That can achieve integrated hub motor system that will be reflected in enhanced structure to each component of electric vehicle systems, in addition to, Interior Search Algorithm (ISA) will be applied to control and optimize the performance parameters.

The patent presents Resilient In-Wheel-Motor (RIWM) technology with an enhanced scheme to control the regenerative power that can be delivered by hybrid and electric vehicles to be faster and with a lower total cost than other electric drive systems. Hub motors have been included a built-in inverter, control electronics, software and smart battery management that simplify the adoption of hybrid and electrified powertrains across a broad range of vehicles, based on add new performance feature to handle some existing challenges that will be mentioned bellow. The objective of the paper is to propose hub motor that is incorporated with high-speed dynamic energy storage as fast batteries, ultracapacitors and small flywheel units. That can achieve integrated hub motor system that will be reflected in enhanced structure to each component of electric vehicle systems.

RIWM will have improved electronic regenerative system. Common regenerative systems utilise both electrical and friction braking due to the efficiency of the motor when placed in a circuit to resist energy running opposite to the motors spinning direction. While this system still utilises frictional braking, it is only used to collect the braking torque lost with the efficiency of the motor. Some car manufacturers such as Tesla who utilise the energy of the motor to brake in order to recover some of the power. They say that the efficiency of this would be the efficiency of the output from the motor times the efficiency of the output of the motor since the motor controller links the circuit to have the motor using its kinetic energy to convert its mechanical energy back into electric energy. This is also a packaged design which would be in the car relative to the wheel. However, this means that it would be cheaper and easier to diagnose faults this the electrical system.

The benefit of the using a Continuously Variable Transmission (CVT) is that the gear ratios can change to an infinitesimal degree where there is no limit to the number of gears for the size of the transmission. This means that the transmission creates a compact design for a regenerative braking system. This system utilises a multi-disk clutch since a single clutch plate would leave an exposed multi fulcrum lever in order to compress the diaphragm spring which would cause so difficulty for the packaging. The CVT is exposed for demonstration purposes; however, in the typical automotive industry, the CVT is encased in a cast casing to protect the moving parts. Inside the CVT there are two compression spring which is linearly actuated to move the outside conical pulley closer or further apart from the opposite side. With the CVT converting the torque the generator picks up the energy and converts it from the kinetic into electric energy to be stored in the battery pack or capacitor to be used again.

FIG. 1 shows the control systems of RIWM, which are categorized to 3 subcategories: power electronics, powertrain, and drive control. FIG. 2 indicates the integration system and connection between multiple RIWMs. There are some challenges related to hub motor systems, one of them is vehicle control and dynamics, in addition to, rapid torque response and ability to produce motoring and braking torque. Other challenges are optimization of regenerative braking that requires detailed study and is a trade-off between performance and cost/complexity. Torque vectoring is another challenge research point at different wheels to enhance dynamic performance of the vehicle. Enhanced hub motor will propose different levels of research to enhance the design and operation of hub motor systems and handle the mentioned challenges.

FIG. 3 shows the force sensor corresponding voltage output for force reading, it is based on different sensors. Each sensor has its corresponding sensitivity. Hybrid energy storage system, as advanced type of storage systems as ultracapactiors and electrical flywheels, and fast charging batteries can be applied with hub motor technology to enhance the recharge power capability with decreasing the required charging time and increasing the system life time. That will lead to increase the ability to handle the charging/discharging states in seconds and for very large numbers of times due to the very high-speed dynamic response of those advanced storage systems. Direct Drive Motor (DDM) is a permanent magnet synchronous motor that is used in hub motor systems to drives the load. There is no transmission or gearbox for this configuration and is a frameless system which means that there are no housing, bearings, or feedback sensors are necessary. The outcome of more poles equals a higher torque output there are three main types of DDM. DDM are mainly used for their small sized, low weight characteristics that provide minimal power and optimal speed control.

This Regenerative braking system utilises common variable transmission (CVT) to vary the braking torque being put into the electric generator. When braking the clutch in the system engages the CVT, which converts the higher RPM into a larger amount of torque by reducing the gear ratio. As the wheel rpm decreases the gear ratio changes since the pulley diameter can change. It can change to provide a constant torque back into the battery energy system. One disadvantage with this system is that since a CVT requires the use of belts and pulleys, the transmission torque is limited by the friction due to contact. As a result, an option is fitting a gearbox to convert the wheels low rpm and high torque to a more manageable lower torque and higher rpm for the CVT to operate under. The friction on the belt is dependent on the angle of contact for the V-shaped belt which is generally used, however since the pulleys angle changes the belt must adjust to having a secure grip. Therefore, mechanical pulley belts are used which flex depending on the contact angle required in order to have a better grip on the changing pulley. Although this still means that the regenerative system is not in-board, it does mean that there is more flexibility with the packaging of the transmission.

While it is not entirely necessary for the pulley to have a higher maximum braking torque, between the motor and clutch is the option to position a gearbox with a preselected ratio that increases the RPM giving the CVT a lower amount of torque. This also means that the clutch plates can be smaller as there is less required torque in order to use the braking system. One drawback that this might have is that in order to achieve the same amount of energy being put back into the system

While electric motors have been around almost as long as combustion engines. Electric in hub motors are in recent years gaining traction. Some early attempts at in-hub electric motors include the Lohner-Porsche hybrid and the Lunar Rover. Both of these were some of the first attempts of in-hub electric motors with the Lunar Rover being all-wheel drive and the Lohner Porsche being two-wheeled drive. These were meant for applications for scenarios which needed a limited number of intricate moving parts while maximizing the space usage. Differentials are an early technology used to split the torque of the wheel in order to have two different rotational speeds. The replacement of the differential so that the computer can provide forgiveness to the wheel which spins simultaneously, creating a programmable standard, slip or locked differential. Furthermore, other electric technologies have been explored in the idea of efficiency. Regenerative braking is an area only discovered recently with the further research assistance of motorsport.

Expensive modern electric cars have incorporated a braking system which put energy back into the storage system. Majority of the electric cars now utilises this system as well as a method of hydraulically operated friction disk brakes as a more immediate alternative way of stopping the vehicle. Depending on the driver's preference the energy regenerative brakes can be adjusted to harvest more energy when the accelerating pedal is released. To mathematically represent the results to the driver input, functions can be made in order to best find the resulting correction for the yaw rate and sideslip angles. The wheel steering angle can be approximated by a sine curve under a certain driving condition. While maintaining a constant velocity, the single wheel steering angle can be set to vary depending on the state of the multiple sine curves. The response of the actual yaw rate with and without control to nominal yaw rate under single-lane driving condition coincides with the actual side slip angle when at the mass centre with and without control.

FIG. 4 shows the fully assembled Electric wheel Platform with the structure of the wheel, controllers, and brake system. There are many advantages to which the vehicle's powertrain to in-wheel motor design, however making this decision has some drawbacks which affect the quality of the vehicle. In most in-wheel motor designs, there are vibrations which are generated due to an interaction between the torque ripple and the rotor field which reaches a high level of harmonics. This can be seen with the concentrated winding of the stator field harmonics. Although this is present with all types of motors the Switched Reluctance motor is generally preferred for the distributed winding type, whereas with Permanent Magnet synchronous machines a Concentrated Winding which has limitations due to typically high stator field harmonics.

In order to retrieve the kinetic energy produced by the electric wheel. We need to look into how the electric motor we have sourced behaves under the motor to battery braking efficiency. This can be achieved using the QS motor, which produces 8000 W that when placed with the motor and battery, the motor acts as a generator. To increase the braking torque required to run the generator. Additional power is provided to the circuit to slow the wheel further and still recover the energy to the electric energy system.

Regenerative Braking: Different companies explore different areas of regenerative braking in order to improve electric vehicle power usage. One of the areas in the regenerative braking field is the use of E-REV bus, which is a type of coast that utilises the kinetic energy in the vehicle during the acceleration and uses the stored energy without the use of additional energy during the coasting of the vehicle. This can be compared with the regenerative braking system to the constant driving style. Studies have shown that when coasting with regenerative braking, there shows an increase in 3.5% in fuel economy. When comparing the use of coasting to traditional braking, the fuel economy can improve by 39.7%, although it isn't a large factor the regenerative braking does have a role in improving the fuel economy.

FIG. 5 shows the energetic and economics functions for a RIWM. The existing functions are possible innovation and improvement. Throughout the industry, there are different types of motors used for different applications. One type of motor is the Brushed DC motor, which is great for achieving a high amount of torque but is not very efficient from the loss due to friction and requires a lot of maintenance. The motor is also larger than most motors with their large construction and inability to downsize. Another type of motor is the Induction Motor. This motor has a dependable, durable construction which makes it able to work in hostile environments. However, this type of motor requires a specific type of motor controller, which makes it very expensive. The efficiency is also lower than other motors that are available on the market such as, the Permanent Magnet Brushless DC (PM BLDC) and the Switched Reluctance Motor (SRM). PM BLDC motor is commonly used due to its high efficiency and high-power density. High efficiency is due to the use of permanent magnets since they do not require energy to make them magnetic. However, due to their rarity, they are also more expensive and are trying to phase-out as they depend on a limited resource. Finally, the best option to select would be the SRM due to its fault-tolerant operation, simple control and great torque-speed that is available across a constant power range giving it high-speed capabilities. This motor does not feature a magnetic source giving it a low moment of inertia for quick acceleration. The simplistic rotor structure also makes it easy to cool the motor while achieving higher speeds. The SRM, however, does suffer from a torque ripple and acoustic noise which is common in most in-hub motor designs. Although these faults do not make this type of motor inapplicable to our application, we selected the PMBLDC motor since this is a motor which is widely available and more efficient than the SRM. The efficiency of the motor is important to our application since we want an accurate testing platform to demonstrate this technology.

FIG. 6 shows the control functions for a RIWM, and FIG. 7 indicates Energy Systems of RIWM where the objective is to achieve a novel design of integrated in-wheel motor systems that will be reflected in Resilient In-Wheel-Motor (RIWM) technology. RIWM will propose enhanced structure to each component of in-wheel motor system to improve the existing technologies. There are some challenges related to in-wheel motor system, one of them is vehicle control and dynamics, in addition to, rapid torque response and ability to produce motoring and braking torque. Other challenges are optimization of regenerative braking that requires detailed study and is a trade-off between performance and cost/complexity. Torque vectoring is another challenge research point at different wheels to enhance dynamic performance of the vehicle. RIWM will work and propose different levels of research to enhance the design and operation of in-wheel motor system and handle the mentioned challenges as:
Additional e-drive components (battery, motor, inverter)
Electrical ancillary components (DC/DC, power steering, charger)
Interface to standard components.
Entirely independent torque control at each wheel
Four quadrant operation of motors
Both directions of motion and torque
   FIG. 8 presents the interaction between the main components of a RIWM—Level 1, and FIG. 9 shows the interaction between the main components of a RIWM—Level 2. There are cases that have been studied by different modelling and key performance indicators. There have been sections about interaction between the main components of a RIWM—Level 1 and Level 2, RIWM models with details for each main system identify for a RIWM, and possible enhances and innovation for each system in a RIWM. Main RIWM producers and technical specifications have been presented to highlight the main features and parameter values of the existing technology that will help in the simulation parameters and operating ranges.

There are some features related to in-wheel motor system, one of them is vehicle control and dynamics, in addition to, rapid torque response and ability to produce motoring and braking torque. Other feature is optimization of regenerative braking that is required to enhance dynamic performance of the vehicle. With a typical in-board electric motor on the market today the motor goes through a gearbox and then a differential before getting to the wheel. As much as 8% efficiency can be lost when power passes through all those components. With RIWM electric motors and controls directly connected to the wheel, the 98% efficiency is going right to the wheel. RIWM will propose different enhancements in the e-drive components (battery, motor, inverter), Electrical ancillary components (DC/DC, power steering, charger) to interface to standard components with entirely independent torque control at each wheel, four quadrant operation of motors and both directions of motion and torque. A conceptual idea about the model for a RIWM has been presented to show details about the main systems identify for an RIWM and to show proposed enhanced and innovations for each function.

### REFERENCE TO DRAWINGS

FIG. 1 shows the control systems of RIWM, which are categorized to 3 subcategories: power electronics, powertrain, and drive control. FIG. 2 indicates the integration system and connection between multiple RIWMs. There are some challenges related to hub motor systems, one of them is vehicle control and dynamics, in addition to, rapid torque response and ability to produce motoring and braking torque. Other challenges are optimization of regenerative braking that requires detailed study and is a trade-off between performance and cost/complexity. Torque vectoring is another challenge research point at different wheels to enhance dynamic performance of the vehicle. Enhanced hub motor will propose different levels of research to enhance the design and operation of hub motor systems and handle the mentioned challenges.

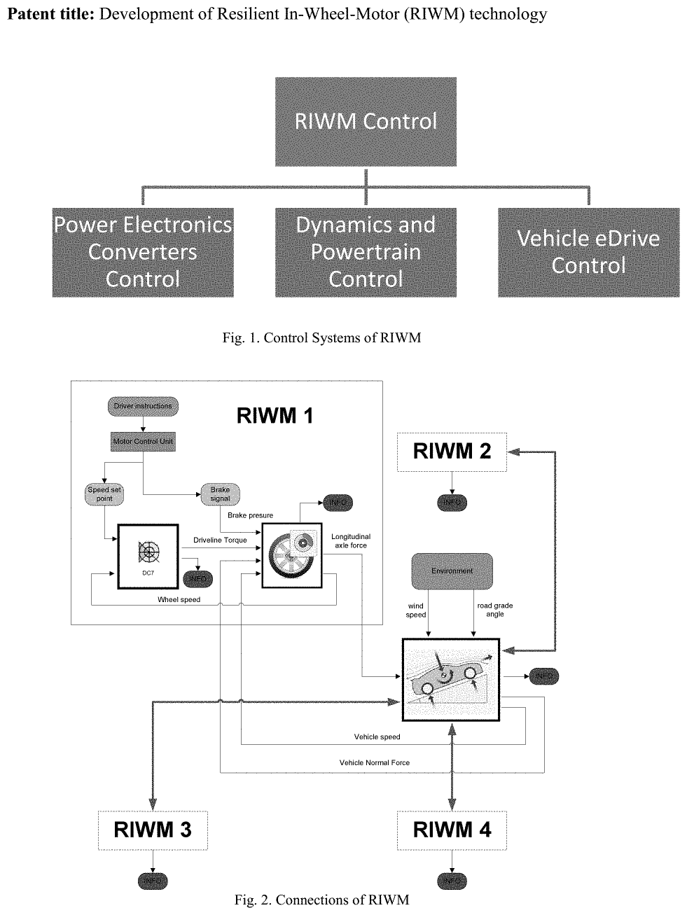

FIG. 3 shows the force sensor corresponding voltage output for force reading, it is based on different sensors. Each sensor has its corresponding sensitivity. Hybrid energy storage system, as advanced type of storage systems as ultracapactiors and electrical flywheels, and fast charging batteries can be applied with hub motor technology to enhance the recharge power capability with decreasing the required charging time and increasing the system life time. That will lead to increase the ability to handle the charging/discharging states in seconds and for very large numbers of times due to the very high-speed dynamic response of those advanced storage systems.

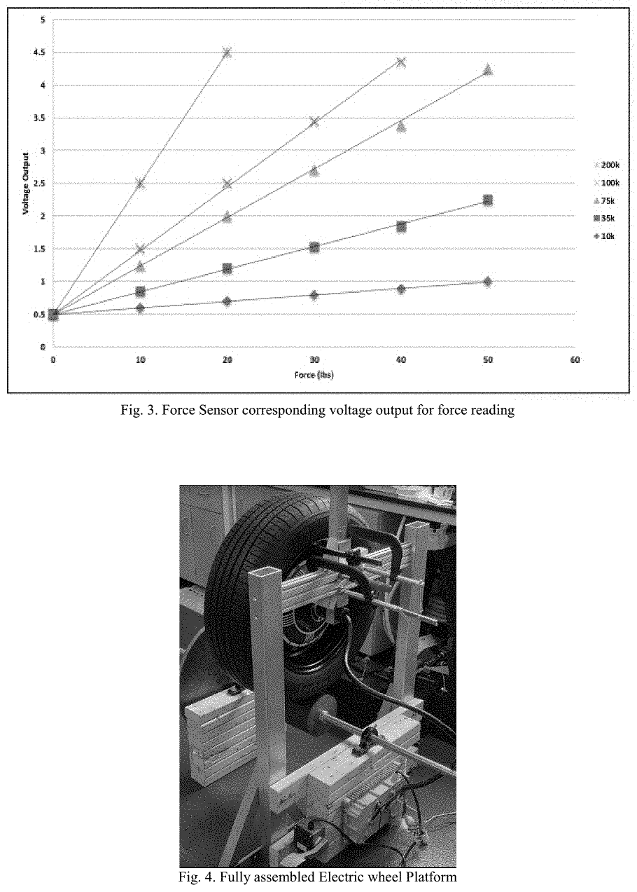

FIG. 4 shows the fully assembled Electric wheel Platform with the structure of the wheel, controllers, and brake system. There are many advantages to which the vehicle's powertrain to in-wheel motor design, however making this decision has some drawbacks which affect the quality of the vehicle. In most in-wheel motor designs, there are vibrations which are generated due to an interaction between the torque ripple and the rotor field which reaches a high level of harmonics. This can be seen with the concentrated winding of the stator field harmonics. Although this is present with all types of motors the Switched Reluctance motor is generally preferred for the distributed winding type, whereas with Permanent Magnet synchronous machines a Concentrated Winding which has limitations due to typically high stator field harmonics.

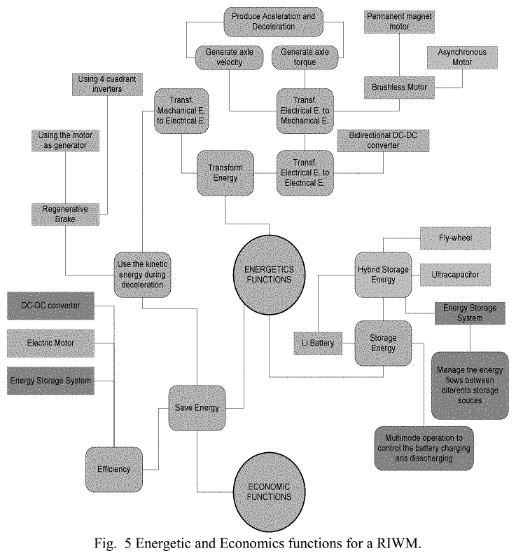

FIG. 5 shows the energetic and economics functions for a RIWM. The existing functions are possible innovation and improvement. Throughout the industry, there are different types of motors used for different applications. One type of motor is the Brushed DC motor, which is great for achieving a high amount of torque but is not very efficient from the loss due to friction and requires a lot of maintenance. The motor is also larger than most motors with their large construction and inability to downsize. Another type of motor is the Induction Motor. This motor has a dependable, durable construction which makes it able to work in hostile environments. However, this type of motor requires a specific type of motor controller, which makes it very expensive.

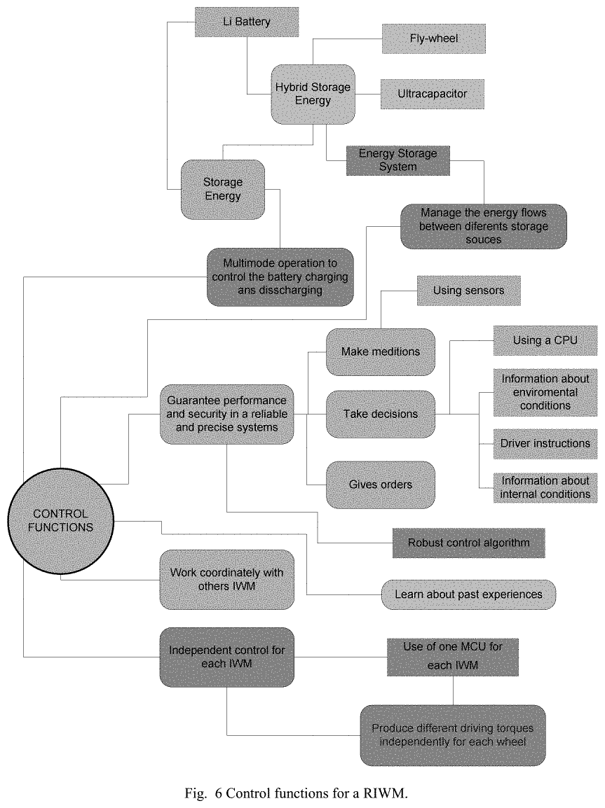

FIG. 6 shows the control functions for a RIWM, and FIG. 7 indicates Energy Systems of RIWM where the objective is to achieve a novel design of integrated in-wheel motor systems that will be reflected in Resilient In-Wheel-Motor (RIWM) technology. RIWM will propose enhanced structure to each component of in-wheel motor system to improve the existing technologies. There are some challenges related to in-wheel motor system, one of them is vehicle control and dynamics, in addition to, rapid torque response and ability to produce motoring and braking torque. Other challenges are optimization of regenerative braking that requires detailed study and is a trade-off between performance and cost/complexity. Torque vectoring is another challenge research point at different wheels to enhance dynamic performance of the vehicle. RIWM will work and propose different levels of research to enhance the design and operation of in-wheel motor system and handle the mentioned challenges.

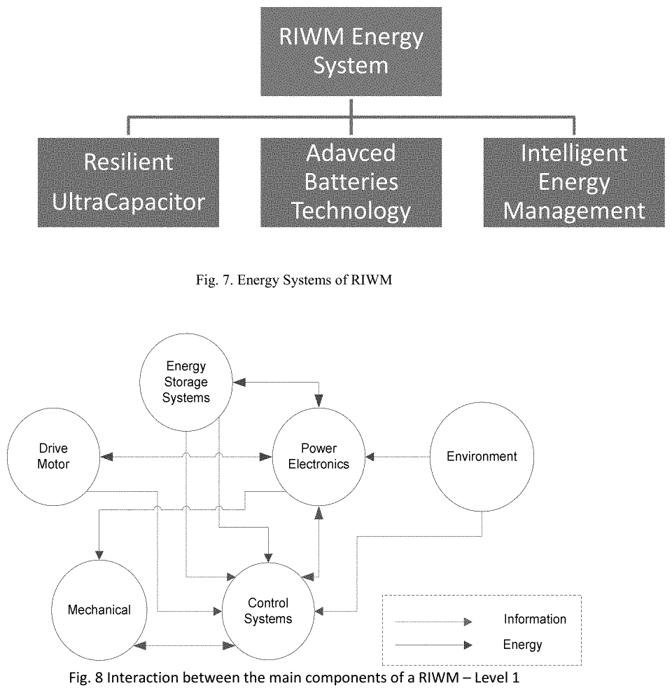

FIG. 8 presents the interaction between the main components of a RIWM—Level 1, and FIG. 9 shows the interaction between the main components of a RIWM—Level 2. There are cases that have been studied by different modelling and key performance indicators. There have been sections about interaction between the main components of a RIWM Level 1 and Level 2, RIWM models with details for each main system identify for a RIWM, and possible enhances and innovation for each system in a RIWM. Main RIWM producers and technical specifications have been presented to highlight the main features and parameter values of the existing technology that will help in the simulation parameters and operating ranges.

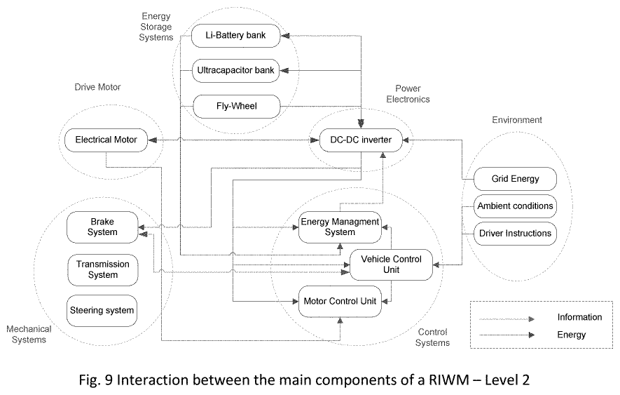

1: Develop of Resilient In-Wheel-Motor (RIWM) that have integrated schemes and technologies to ensure optimum and high efficient energy system. RIWM includes advanced hybrid energy storage system, which is one of the most promising technologies for replacing conventional batteries as energy storage systems for a variety of applications, including automobiles, economical electrification systems.

2: RIWM is applied as alternative technology for currently existing technology, or to be integrated with them to achieve optimum performance. It is include the configuration design, control, monitoring, and performance optimization of the integrated RIWM as interconnected with electric vehicles, buses, and trains.

3: With RIWM electric motors and controls directly connected to the wheel, the 98% efficiency is going right to the wheel. RIWM will propose different enhancements in the e-drive components (battery, motor, inverter), Electrical ancillary components (DC/DC, power steering, charger) to interface to standard components with entirely independent torque control at each wheel, four quadrant operation of motors and both directions of motion and torque.

4: Add additional Eddy-Current brake, the control strategies to manage the dynamic brake and its interaction with base powertrain to have performed good correspondence with the imposed reference values in terms of vehicle speed and mechanical torque.

5: Use a 6-phase motor as a squirrel cage motor (induction) with a control system that is robust to be sensitive to differences between the actual system and the nominal model of the system which is used in the controller design. These differences are considered as model uncertainty or perturbations.

6: Multimode operation ZEBRA batteries use plain salt and nickel as the raw material for their electrodes in combination with a ceramic electrolyte and a molten salt. This combination provides a battery system related specific energy of 120 Wh/kg and a specific power of 180 W/kg. With these data the battery is well designed for all types of electric vehicles and hybrid electric buses.

7: Add additional Eddy-Current brake, the control strategies to manage the dynamic brake and its interaction with base powertrain to have performed good correspondence with the imposed reference values in terms of vehicle speed and mechanical torque.
